(19) United States
(12) Patent Application Publication
(10) Pub. No.: US 2007/0078962 A1
(43) Pub. Date: Apr. 5, 2007

(54) System, method and software for creating, maintaining, navigating or manipulating relationships and communications within a private network or private virtual network for gaming and reporting

(75) Inventors: Robert M. Donnelli, Scottsdale, AZ (US); Sean M. O'Brien, Enterprise, AL (US); John Jason Gentry Mullins, Pleasanton, CA (US)

Correspondence Address: John J G Mullins, 1618 East Gate Way #304, Pleasanton, CA, 94566, US

(73) Assignee: Boloto, Inc.

(21) Appl. No.: 11/320,117

(22) Filed: Dec. 27, 2005

Related U.S. Application Data
(60) Provisional application No. 60/722,326, filed on Sep. 30, 2005.

(51) Int. Cl. G06F 15/173

(52) U.S. Cl. 709/223

(57) ABSTRACT

The field of the present invention relates generally to computer systems, private computer networks or private virtual networks for managed peer to peer or peer to server communications with respect to activities of chance such as gaming and investing and to methods and software for accessing, utilizing and managing private computer networks or virtual private networks including servers and clients. More particularly, the present invention relates to a system, methods and software for creating, maintaining, accessing, navigating and persisting relationship between servers with other servers and/or clients within a private or virtual private network for managed peer to peer communications for activities of chance such as gaming or investing. In one aspect, the invention also relates to an application programming interface (“API”) and software useful for creating, maintaining, accessing, navigating and persisting such relationships as a complex relationship graph, or as a set of complex relationship graphs in an environment supporting activities of chance such as investing or gaming.

### FIELD OF THE INVENTION

The field of the present invention relates generally to computer systems, private computer networks or private virtual networks for managed peer to peer or peer to server communications and to methods and software for accessing, utilizing and managing private computer networks or virtual private networks including servers and clients for a secured gaming. More particularly, the present invention relates to a system, methods and software for creating, maintaining, accessing, navigating and persisting relationship between servers with other servers and/or clients within a private or virtual private network for managed peer to peer or peer to server communications with respect to gaming. In one aspect, the invention also relates to an application programming interface (“API”) and software useful for creating, maintaining, accessing, navigating and persisting such relationships as a complex relationship graph, or as a set of complex relationship graphs in order to permit secured gaming.

### BACKGROUND OF THE INVENTION

Systems for creating or accessing networks for server to peer and peer to peer communications have been used in the past few years, but are not secure enough for gaming in an efficient manner. A frequent approach to accomplish access to such private networks is to have an unmanaged, or a limited management of the virtual private networks other than granting permission to access the network and giving the user the addresses to peers or servers on the network. Unfortunately, unmanaged or limited managements fall short of providing secured gaming that will meet reporting standards for tax purposes while maintaining autonomy and privacy for the gaming individual. In prior networks, the actual management of attachments is controlled by the user, which has led to abuse of the system and impermissible gaming activities via unmanaged peer to peer communications where the identity of the peers is unknown to the network administrator. U.S. Pat. No. 5,884,031, issued to Ice on Mar. 16, 1999 is an example of such a virtually unmanaged and unmanageable network of the type frequently used by peer to peer gaming individuals. Other gaming networks are closed networks such as those available at a casino or other physical satellite location and do not permit the comfort of gaming from one's private location in a way that will meet regulatory standards. Logging in to an online casino is also not very secure and is limited as to the availability of different types of gaming.

Accordingly, there is a need for a managed and secure network or virtual network of unlimited size with respect to servers and client for peer to peer communications where the identity of each client is known to the network, but not necessarily known by the individual peers who communicate with each other and will permit unlimited gaming opportunites while meeting regulatory standards for tax purposes and reporting. There is a need for such a network which can provide unlimited communications within the private network or private virtual network for gaming purposes in a way that will meet regulatory and tax standards with respect to identification and reporting.

### Managing Networks As An Object Graph

A geographic problem of physical locations complicates the creation, access, changing or deleting of a set of network relationships between clients and servers, between two clients (peer to peer where one or more may also be acting as a server for a particular transaction). The network or virtual network may be distributed over multiple physical computer machine locations or even distributed over multiple Internet website locations including connections between portable devices such as mobile phones, PDA and other wireless devices that may be independent of the core private network or from a central machine. Thus, in the context of this invention, the relationships between such entities may be managed as an object graph of complex object relationships using object based programming languages and software.

Importantly, relationships may exist between a two servers, between a client and a server, or between two clients that may be represented using an object model and object programming software according to the present invention. A relationship between one such entity and another may be member selected from the group of three relationship types consisting of 1 to 1 (1-1), 1 to many (1-M) or many to many (M-M). Complex combinations of these relationships may be thought of in the context of this invention of managing network relationships as an object graphs as existing in data object relationships definitions for a given data object for management. These relationships are described or illustrated in further detail later in this document.

An example of such a relationship would be the relationships in a virtual poker game or virtual blackjack game. The relationship between the dealer and the players would be 1 to many in a blackjack game, while the relationship between the individual players and the dealer is 1 to 1, while their relationship to one another is one to many. In a poker game or in a bridge game, there will be different relationships and even teams. All of these relationships can be managed by an object graph of relationships and the data of bids, bets, wins and losses can be managed as data for each object on the graph, which is each player.

As is clear from the above illustration, objects may logically span multiple relational tables or multiple object databases, and may even be distributed over a logical (or hypothetical) computer system involving multiple physically independent computer systems or even multiple website locations, multiple players, multiple games and multiple locations. Creating, accessing, maintaining or updating an object application model can require working with multiple translation modules and require tedious and repetitive updating of multiple individual computer systems or multiple data sources in order to do useful work and keep the object application model synchronized. Such approaches are both costly and unwieldy in terms of computing and development resources, particularly with respect to Internet based private network and virtual private network communications and transactions object application models.

Data objects of an object application model are often a feature of eCommerce object programming applications, where information is obtained from a data source and the data is defined as a data object (e.g., as a Java class) for use with another computer application. However, the present invention modifies and applies this practice to a network in order to provide network management utilizing an object programming language with objects describing and encapsulating the relationships of entities utilizing and serving the private network and persisting them to a data store. In practice, a data object or model of data objects may exist only in the random access memory of a computer memory system, or may be saved to either a data source or to some other type of retrievable information repository. A programmer or administrator of an object data application may not be able to exhaustively display the overall model or diagram of data objects for an object application model or to display some of its specific elements. Unfortunately, tools for accessing and displaying data objects and associated data object relationships as a complex data object graph model have not been well implemented in the field of object language programming.

A computer application can execute one or more of the following non-limiting actions with respect to one or more of the members selected from the group consisting of data, a data object, and a data object definition: access data, change data, create data, create a new relationship between one or more data objects by creating or changing at least one data object relationship definition, change or delete a relationship between one or more data objects by changing or deleting at least one data object relationship definition, access a data object relationship definition and use its parameters to access a data source or a data object, and access one or more data object relationship definitions or data objects to create a new data object or data object relationship. Any changes executed by a computer application with respect to one or more of the members selected from the group consisting of data, data object or data object definition may need to be properly persisted (permanently stored) to preserve any changes to one or more of the members selected from the group consisting of data, a data object and a data object definition.

A data object and an associated data object relationship definition may be represented by a complex data object graph as described in published U.S. patent application Ser. No. 10/158,672 to Ward Mullins (assignee Thought, Inc.). A Complex Data Object Graph (CDOG), for the purposes of this document, may be thought of as a computer program data object graph that represents a data object having at least one relationship with at least one other data object or with itself via a circular link. When the data object of a CDOG is implemented in the Java computer program language, the CDOG may be further defined as being a Java Data Object Graph (“JDOG”).

There is a need for an easily navigable tool for detecting any relationships of a data object in the context of a virtual private network that provides gaming in order to provide both a full description and management of servers and clients, games and players along with their concurrent limits, bets, winnings and reports within the network as a CDOG definition and for persisting any changes to at least one member selected from the group consisting of a data object, any data associated with the related object, or any associated CDOG definition (i.e., an changes to the data object, data or to a relationship of the data object with another data object). For example, there is a need to be able to properly create, manage and sever relationships between at least two data objects (such as players in the gaming environment) in a convenient and efficient manner by simply making a change to the CDOG definition for one of the two related data objects.

There is currently no computer programmer or system administrator tool that is efficiently adapted for managing a private network or virtual private network in a gaming environment as an object application using a CDOG model with features that permit convenient and efficient accessing and deleting of a single instance of a complex data object and (without further input) results in the tool automatically deleting all existing associated data objects and relationships and the tool automatically updating all local and distributed instances of the CDOG and its associated data, data objects and data object relationships on the local or distributed computer system.

Accordingly, there is a strong need in the art for a computer applications system and programmer tools designed to assist a programmer or administrator in the actions of deleting, inactivating or updating of relationships and communications within a private network or a virtual private network as a complex data object graph for gaming purposes, wherein the computer applications programmer tool can be configured to automatically delete, inactivate or update at least one member selected from the group consisting of associated data, associated data objects and associated data object relationship definitions to reflect the deleting, inactivating or updating of a CDOG. A particularly strong need exists for such a tool or system having the further ability to be configured to persist, propagate and reflect system wide (in a local or distributed computer system) any such changes to a CDOG instance to all instances of the CDOG and to all instances of associated data, data objects and data object relationships that represent relationships and communications within a private network or a virtual private network for gaming purposes.

### Definitions

The following non-exhaustive list of definitions is used herein to define terms that may otherwise be confusing or can sometimes have multiple meanings. Each occurrence of a defined term in the above text, in the text that follows, or in the claims of this document, is to be given the meaning ascribed to it in the list of definitions below.

“Instance” as referred to in this document in the context of computer software applications is a single occurrence of a software logical element in the memory of a computer system, such as a “class”, an “object”, a “data object”, and the like.

“Class” as referred to in this document in the context of computer software applications is a logic unit in a computer application or a computer software program where the application or program is based upon an objected oriented programming language (e.g., Java). In practice, a class is a logical unit used as a logical template in an object oriented language from which to allocate new instances of objects.

“Object” as used in the context of this document is a general term referring to a logic unit in a computer application or a computer software program where the application or program is based upon an objected oriented programming language (e.g., Java). The term “object” may ordinarily be used interchangeably with the term “class” as a template or as an instance depending on the context.

“Data object” as referred to in the context of this document represents the concept of the occurrence of an object that holds data within a specific computer application domain and is likely to have its contents stored in a persistent data source of a computer system (e.g., a database server, a binary file, a text file, or even in a combination of two or more of such a persistent data sources of a computer system). A data object may exist as an independent data object without any relationship to any other data object or it may have one or more relationships with itself or with one or more other data objects.

“Complex data object” (or “CDO”) as used in the context of this document refers to the occurrence of a data object that has at least one or more relationships with itself, or at least one or more relationships with one or more other data object(s). In a given instance of a CDO at least one relationship is populated as a link, as defined below. A CDO may have a multiplicity of different relationships with itself or with one or more additional CDOs.

“Relationship” or “data relationship” as used in the context of a CDO refers to the type of logical combination that occurs between a data object with itself, or refers to the type of logical combination that occurs between a data object and at least one another data object. Among other references or descriptions, such a relationship is always referred to or partially described by a “relationship type”. This term is used in an object oriented language context to reference or describe any expectations, actions and limitations possible between two or more data objects.

“Relationship type” in the context of this document is a label that specifies the possible multiple combinations that can occur between a CDO and itself or with at least one other CDO. The possible relationship type labels are 1-1 (one to one), 1-M (one to many) and M-M (many to many). A given CDO may be simultaneously related to more than one other CDO through several different types of relationship.

“Link” as used in this document with respect to a CDO identifies a particular occurrence of a relationship between a CDO and itself, between a CDO and another CDO. The occurrence of at least one populated link results in an instance of the CDO.

“Circular link” as used in this document with respect to a CDO identifies a particular occurrence of a relationship between a CDO and itself that may be direct or indirect (e.g., linked to itself through another CDO).

“Relationship definition” or “relationship description” in the context of this document and computer software applications refers to information, or an abstraction of information, regarding a “relationship”, “data relationship” “relationship type” or a “link” that can be stored, accessed, transferred, communicated, displayed or edited.

“Complex data object graph” or “CDOG” is a term employed herein as an abstraction to logically represent a set of complex data objects and a set of their corresponding relationships.

“Java data object graph” or “JDOG” is a term employed herein as an abstraction to logically represent a set of complex data objects and a set of their corresponding relationships that are part of a Java programming application.

“Application model” or simply “model” are essentially interchangeable terms employed herein as abstractions to logically convey a collective description or other representation for a set of complex data objects and a corresponding description or other representation of their relationships. In one respect, these terms are used logically herein provide a general way of efficiently communicating when referring to set of metadata (i.e., data about data) that describes possible data entities (e.g., objects, database tables, maps, etc,) data relationship types, and data constraints involved in a computer system or application, or in a specific instance of an application. It is important to understand the context in which the terms “application model” and “model” are used in this document. Ordinarily computer engineers refer to the “model” as an abstraction rather than a specific possibility or instance of the model as applied. However, in this document for the ease of communication abstractions of the model, possible implementations of the model and instances of the model are all referred to generally as “application model” or “model”. From the context of its use the term will be clear.

“Navigation”, “navigating” or “navigated” in the context of the present document refers to an action implementing at least one object to interact with a set of related objects for a certain purpose, such as creation, access, insertion, modification and deletion of an object, or of one of its relationships.

“Navigation model” as used herein is a special type of application model that is applied specifically to a description (or other representation) of how objects can relate to each other and what might be the expected behavior when a CDOG is navigated for a certain purpose.

“Object schema” is a term employed herein as an abstraction referring to the set of data object classes that describe the possible data objects that can be created, modified or maintained in an application, or describing an instance of a set of data object classes in an application.

“Gaming” is a term employed herein as an abstraction referring to any type of activity involving chance and the possibility of winning where an outcome is not certain, and it is possible to bet upon one's likelihood winning at a particular activity or the likelihood of someone else winning where the loser pays and the winner is paid. Further, the “house” may server as a broker to the transaction and collect certain commissions or percentages from either the winners or losers or both. Examples are card games, sporting events, horse racing, the lottery, and the like.

### SUMMARY OF THE INVENTION

An object of the present invention is to provide a system for creating, maintaining, accessing, navigating and persisting relationships between servers, between servers and clients, and between clients, as complex data objects within a complex data object graph (CDOG) model in order to provide an improved system for gaming activities, wherein clients or servers may be large computer systems or networks or may be a system that includes wireless devices such as mobile telephones, PDAs or other wireless communication devices. In a preferred embodiment, an object of the present invention is to provide such a system that can display and manage the relationships within a private network or within a virtual private network as CDOG model that may be represented as a graph or table of complex data objects. A further object is to provide such a system that is located on, or is part of, a local or distributed computer system that may include wireless devices not limited to PDA, mobile phones, portable computers or other wireless communication devices capable of communicating within a network.

An object of the present invention is to provide a method for creating, maintaining, accessing, navigating and persisting network relationships as complex data objects stores as a complex data object graph. In a preferred embodiment, an object of the present invention is to provide such a method having the step of displaying or printing a representation of the relationships within a private network and a virtual private network as a CDOG model as a graph or table of complex data objects with respect to gaming activities. In a further object, such a method involves a local or distributed computer system wherein individuals are identified by unique identifiers that may include histories of their online activities habits, recorded individual background information, unique passwords, machine identifiers, digital identifiers such as voice, finger print and eye scans, and the like, or any combination of one or more of such identifiers sufficient to provide a clear identity for any individual who is logging into the network to join into gaming activities.

An object of the present invention is to provide a computer software program having at least one user interface and having at least one feature for at least one action selected from the group consisting of creating, maintaining, accessing, navigating and persisting relationships within a private network or within a virtual private network as complex data objects via a complex data object graft model with respect to gaming activities and associated data. In a preferred aspect, an object of the present invention is to provide software program with a module or associated software program having a feature for displaying or printing a representation of the relationships and associated data as a CDOG model as a graph or table of complex data objects. In a preferred object of the invention, such a software program has an editing interface for editing a CDOG model, or an editable input or source, such as a file, that can be modified to implement changes to a CDOG model. A further object is to provide such a software program adapted for a local or distributed computer system that permits internet or intranet gaming in a secure network or virtual network setting.

An object of the present invention is to provide an application programming interface (“API”), as a preferred embodiment of the invention, wherein the API can be accessed to create, maintain, access, navigate and persist network relationships as complex data objects while representing such relationships as a CDOG model, or as an object schema that is adapted for gaming, gaming data tracking, and gaming reporting. In one aspect the API can be accessed by a computer software program, or by a computer software program module that is part of a software package including the API, to provide at least one action selected from the group consisting of creating, maintaining, accessing, navigating and persisting network relationships as complex data objects within a complex data object model adapted for gaming. In a preferred aspect, an object of the present invention is to provide such an API as part of a software package having a component or method for displaying or printing a representation of such gaming relationships and associated data as a CDOG model illustrated or represented as a graph or as a table(s) of complex data objects. In another preferred object, such a software tool package including the API would be provided with an editing interface for editing the network relationships associated with gaming as a CDOG model, or has an editable input or source, such as a file, that can be modified to implement changes to the complex data object model. It is a particularly preferred object to provide such an interface as a point and click graphical user interface that may be displayed and/or edited. A further object is to provide such a API for operation on a local or distributed computer system that implements secured intranet or internet gaming.

A preferred object of the present invention is to provide a software tool or system comprising the API according ( as described above), adapted for a local network or a distributed network gaming environment, wherein said software tool provides persistence for activities and data within the gaming environment in an object oriented language programming environment transparently by implementing a configurable network component capable of acquiring and persisting network relationships and data associated with intranet and internet gaming through network APIs.

A further object of the present invention is to a software tool capable of reading a source programming object logic model or a database file in a format selected from the group consisting of a UML data file,m a XMI data file, and a XML file and converting the information into a target member selected from the group consisting of a database definition XML file, a database mapping definition file, and a CDOG definition file with respect to a secured gaming intranet or internet system. In a preferred object, the software can automatically generate a persistence layer that corresponds to the object model information of the source file that will track activities, data and relationships with respect to gaming.

Another preferred object of the present invention is to provide multi-level or multilevel gaming system,.comprising providing an authorized administrator of the above gaming system to conclusively identify the behavior and actions of an individual user of the system who has giving rights to the administrator to monitor that chance activities data of the individual without violating the privacy rights of the individual and record participation activities outcomes of the identified user with respect to any activity of chance or unpredictable outcome, wherein the participation activity is one or more activities selected from the group consisting of investing in the stock market, investing in a property or business venture other than equity shares purchasing, competitive bidding on an item for purchase, a sporting event, and other such activities that might have an element of chance such that an outcome is not guarantee for that end user, and without violating the privacy right of the user the authorized administrator making available for other third party users of the system some or all of the data regarding the first identified user's activities of chance so that other users may concurrently participate in activities of chance based upon the actions of the first user's activities. For example, for a fee a second user of the system who is an investor may be provided by an administrator an investment activity profile of a first user that does not violate the privacy of the first user in a way that will also not identify the first user wherein the profile includes investments made and outcomes for such investments over a period of time with respect to positive or negative return on investments for the first user, such that a the second user may decide whether to participate in gaming with respect to the success or failure of the first user regarding an ongoing venture or echo the activities of the first investor in the same activity by making similar types of investment activity in parallel to the first user.

### DESCRIPTION THE INVENTION

The present invention provides a system for creating, maintaining, accessing, navigating and persisting relationships between servers, between servers and clients, and between clients, as complex data objects within a complex data object graph (CDOG) model in order to provide an improved system for gaming activities. In a preferred aspect, the present invention provides such a system that can display and manage the relationships within a private network or within a virtual private network as CDOG model that may be represented as a graph or table of complex data objects. A further aspect of the invention provides such a system that is located on, or is part of, a local or distributed computer system.

The present invention provides a method for creating, maintaining, accessing, navigating and persisting network relationships as complex data objects stores as a complex data object graph. In a preferred embodiment, the present invention provides such a method having the step of displaying or printing a representation of the relationships within a private network and a virtual private network as a CDOG model as a graph or table of complex data objects with respect to gaming activities. In a further embodiment, such a method involves a local or distributed computer system wherein individuals are identified by unique identifiers that may include histories of their online activities habits, recorded individual background information, unique passwords, machine identifiers, digital identifiers such as voice, finger print and eye scans, and the like, or any combination of one or more of such identifiers sufficient to provide a clear identity for any individual who is logging into the network to join into gaming activities.

The present invention provides a computer software program having at least one user interface and having at least one feature for at least one action selected from the group consisting of creating, maintaining, accessing, navigating and persisting relationships within a private network or within a virtual private network as complex data objects via a complex data object graft model with respect to gaming activities and associated data. In a preferred aspect, the present invention provides software program with a module or associated software program having a feature for displaying or printing a representation of the relationships and associated data as a CDOG model as a graph or table of complex data objects. In a preferred aspect of the invention, such a software program has an editing interface for editing a CDOG model, or an editable input or source, such as a file, that can be modified to implement changes to a CDOG model. A further embodiment of the invention provides such a software program adapted for a local or distributed computer system that permits internet or intranet gaming in a secure network or virtual network setting.

In one embodiment the present invention is provides an application programming interface (“API”), as a preferred embodiment of the invention, wherein the API can be accessed to create, maintain, access, navigate and persist network relationships as complex data objects while representing such relationships as a CDOG model, or as an object schema that is adapted for gaming, gaming data tracking, and gaming reporting. In one aspect the API can be accessed by a computer software program, or by a computer software program module that is part of a software package including the API, to provide at least one action selected from the group consisting of creating, maintaining, accessing, navigating and persisting network relationships as complex data objects within a complex data object model adapted for gaming. In a preferred aspect, the present invention is provides such an API as part of a software package having a component or method for displaying or printing a representation of such gaming relationships and associated data as a CDOG model illustrated or represented as a graph or as a table(s) of complex data objects. In another preferred aspect of the invention, such a software package including the API would be provided with an editing interface for editing the network relationships associated with gaming as a CDOG model, or has an editable input or source, such as a file, that can be modified to implement changes to the complex data object model. A particularly preferred aspect of the invention provides such an interface as a point and click graphical user interface that may be displayed and/or edited. A further aspect of the invention provides such an API for operation on a local or distributed computer system that implements secured intranet or internet gaming.

A preferred object of the present invention is to provide a software tool or system comprising the API according ( as described above), adapted for a local network or a distributed network gaming environment, wherein said software tool provides persistence for activities and data within the gaming environment in an object oriented language programming environment transparently by implementing a configurable network component capable of acquiring and persisting network relationships and data associated with intranet and internet gaming through network APIs.

Another aspect of the present invention provides end user software or a software tool capable of reading a source programming object logic model or a database file in a format selected from the group consisting of a UML data file,m a XMI data file, and a XML file and converting the information into a target member selected from the group consisting of a database definition XML file, a database mapping definition file, and a CDOG definition file with respect to a secured gaming intranet or internet system. In a preferred aspect, the software can automatically generate a persistence layer that corresponds to the object model information of the source file that will track activities, data and relationships with respect to gaming.

Another preferred aspect of the present invention is to provide a multi-level or multidimensional gaming system, comprising

(i) providing an authorized administrator of the gaming system as described above who has been granted permission by an individual end user or end user team a software module that permits an authorized administrator on the system to conclusively identify an individual end user or end user team to monitor and record online behavior and actions data of that individual user or team within the system with respect to chance activities without violating the privacy rights of the individual to record outcomes,

(ii) providing a software module for compiling outcomes, statistics or both outcomes and statistics from participation activities regarding a particular identified individual user or end user team with respect to any activity of chance or activity of unpredictable outcome, wherein the participation activity is one or more activities selected from the group comprising investing in the stock market, investing in a property or business venture other than equity shares purchasing, competitive bidding on an item for purchase, a physical sporting event, a mental sporting event, a contest, and other such activities that might have an element of chance such that end user or end user team is not guarantee a specific outcome,

(iii) providing a software module for an authorized system administrator to make available for a fee certain or all data, statistics or data and statistics from (i) and (ii) for use by other third party users of the system without violating the privacy rights of the identified end user or team regarding the first identified user or team activities of chance so that other users may concurrently participate in activities of chance based upon the actions of the first user's activities.

In a preferred aspect, the software of the multi-level or multidimensional gaming system provides a software module for individuals to obtain an thumbnail view of the data described above with respect to individual users of the system, without violating the privacy rights of the individuals that the data describes and to decide whether they wish to pay a fee to participate in the multi-level or multidimensional gaming system.

For example, multi-level or multidimensional gaming system and software makes it possible for online participation and wagering on the activities of others with respect to games or activities of chance, such as an online version of the theme of the famous movie “RAT RACE” where 6 sets of individuals effectively wagered their time and travel expenses to be the first to arrive at a certain location (Silver City, N.Mex.) with their copy of 6 duplicate keys to a locker containing a million dollars, while others were giving profile data on the participants and wagered upon who would win the rat race by getting to the locker first and opening it to obtain the million dollars in the locker. Those wagering on the outcome of the race participants were engaging in multi-level gaming, and prior to this invention there was no online way to participate in effectively participate in such multi-level gaming for a variety activities. In fact, the current system would have permitted another higher level of participants to do overview gaming without ever being aware the particular activity (a rat race) to wager on which of the persons wagering on the rat race would be successful in predicting the winner of the rat race.

Another example of this multi-level gaming is with respect to investing. For example, a second user of the system who is a second user investor may pay a fee to the system, after reviewing a thumbnail or summary of the investing success of an individual system user or team of users administrator with respect to their investment activity profile (without violating the privacy of the first user investor or SEC rules) to obtain profile data that does not identify the first user and the profile includes data with respect to investments made and invest results over a period of time with respect to positive or negative returns on investments for the first user, such that a second user may decide whether to participate in gaming with respect to the success or failure of the first user as regards a specific ongoing venture or to receive notifications of investment activity (purchases and sales of equity shares by the first user) of the first user so that the second user can echo the activities of the first investor by making the same types of investment activity or opposite investments in parallel to the first user.

In one embodiment the present invention provides a process for connecting and centrally managing a plurality of multi-tier server computer systems in a gaming system as a single virtual structured network of unlimited size having a network ring structure, a tree structure, or a combination of a network ring and network tree structure, and managing the virtual structured network of tiered server systems from a central location that has access to a repository of information with details regarding each server system included within the network, wherein said process comprises the steps of:
(a) creating one to many and many to many connections between a central server or central server network and two or more second tier server systems that may serve as a node whereby they are in turn optionally connected in a similar manner to form a tree structure, a ring network or a combination thereof, wherein nodes on the ring or tree structure can be connected to one or more sub-tier server systems,
(b) loading from or persisting to at least one storage facility system the information and connection parameters with respect to the server systems managed in the virtual structured network that are necessary to manage the virtual structure network,
(c) loading into the memory of at least one computer system in a network one or more software modules capable of:
   (i) monitoring any additions, deletions or changes to server computer systems within the virtual structured network,
   (ii) monitoring any additions, deletions, or changes to one or more clients connected to a server within the virtual structured network, and
   (iii) persisting such information to at least one repository of information utilized to manage the virtual structured network,
(d) connecting to one or more a client systems directly to a central server system portal through an intranet or internet network connection, accessing information in a repository regarding said one or more client systems, and delegating the connection to one or more tiered servers within the virtual single network system based upon accessed information regarding said one or more client systems, including the steps of:
   (i) accessing information in a repository regarding said one or more client systems that have connected to a central server system portal through an intranet or internet connection;
   (ii) transmitting a request to transfer a connection with a client system to one or more tiered servers within said plurality of tiered server systems;
   (iii) transmitting one or more addresses, of said available server systems connected within said virtual structured network to said client system attached to the portal, or transmitting the address of the client system to one or more server systems; and
   (iv) establishing connections between said one or more tiered server systems and the client system within said virtual structured network,
   (v) monitoring or delegating the monitoring of maintenance of connections between the client system and said one or more tiered server systems within said structured network.

In a preferred embodiment, the above described process additionally comprises a step (e) of maintaining a pre-determined number of connections between each client system that is connected to one or more servers in the plurality of tiered server systems and monitoring the connections with the software of (c) to receive information from said tiered server systems and the connected client system adequate to maintain the status of connections, to establish new connections, or to both maintain the status of connections and establish new of the client system with the tiered server system when a disconnection from at least one server occurs.

In another preferred embodiment, the process described above is a process wherein each node on the virtual network that is available for connections with client systems has a predetermined number of possible connections to existing or new clients systems as a capacity that is stored as information maintained and updated in an information repository that can be accessed by software, which is used to monitor or delegate the monitoring of maintenance of connections between the virtual network and client systems.

In a preferred gaming system embodiment, the process described above provides a step for verifying and tracking a single end user within the system with the ability to monitor and record any activities within the system by that end user.

In another preferred embodiment, the above process is a process wherein said step (c) includes the steps of:
(f) transmitting a disconnection notification from a server system to said monitoring software of (c) that a server system has partly or fully disconnected from a client system within said plurality thereof, wherein said partly disconnected client system has been connected for receiving information from said server system;
(g) said software of (f) responding to said notification of partial disconnection by at least one of the following actions
   (i) transmitting instructions to other servers on the network to creating additional connections of the client system to the virtual network,
   (ii) transmitting addresses and connection information to the partially disconnected client system to permit it to connect with other servers within the virtual network, and
   (iii) transmitting instructions to the servers having current connections with said client system to disconnect said client system from the virtual network

In one embodiment, a process executing within the virtual network as described above includes a process step for establishing a parent-child relationship between the virtual network and sub-branches of the of virtual network server tree system, between the virtual network and a subordinate circular network, or a combination thereof, and providing a virtual private network for a predetermined plurality of server systems, client systems or a combination thereof within the virtual network. For example, a parent child relationship such as this can be utilized to permit registered multi-level gaming participants to be a child to the parent activity of the main gaming activity.

In a preferred embodiment, a process executing within said server system further providing logic and means for establishing a private network of client systems that provide chance activities capability within a plurality thereof such that server systems and client systems may transmit information, receive information, or a combination thereof with respect to gaming, investing, and the like, said process comprising the steps of:
(a) receiving a request for connection to a virtual private network from a client system issuing said request;
(b) determining if said client system has permission to connect to said virtual private network and executing one or more of the following actions
   (i) refusing connection to the virtual private network,
   (ii) requiring actions from said requesting client system in order to receive permission to connect to said virtual private network, and
   (iii) verifying that said client system has permission for connecting to said virtual private network;
(c) after verifying that client system has permission for connecting, determining if a port of said server system within said virtual private network is available for connection with said requesting client system;
(d) if a port of said server system within said virtual private network is available for connection, as determined in step (c), executing actions for connecting said client system issuing said request to said virtual private network;
(e) if a port of said server system is not available for connection within said private network, as determined in step (b), sending to said client system issuing said request a first pre-determined number of addresses of available client systems within said plurality thereof connected within said private network, or suggesting postponing connection to the virtual private network; and
(f) adding information to one or more repositories within the virtual network regarding the said client system issuing said request and their level of permission to join or participate in the virtual private network.

In one preferred embodiment, the invention provides a secure private or virtual private network of unlimited size that, said network or virtual network comprising:
(i) computer software including software logic and at least one interface for a network user to be identified by the network as a, known prior user, or to provide to the network through the interface enough identifying information to qualify as a newly identified network user, with sufficient permission to access the private or virtual private network, and
(ii) computer software including software logic sufficient to verify a network user's identify, and track the network connection of the network user as the network user accesses the private network or virtual private network system.

In a further preferred embodiment, the identity of the network user is determined by user profile information in an encrypted scattered fragmented file and an encrypted index for locating, decrypting, and assembling the scattered fragmented file, which index can only be activated for location, decryption and reassembly of the user profile information file to check against a system information file by a user who provides to the network identifiers that serve as a key to activate the encrypted index.

The present may be embodied in specific forms other than those particularly described above or illustrated by the appended drawings. Upon viewing the present application preferred embodiments and other descriptions herein of the present invention, variations and other implementations that do not depart from the spirit and scope of the present invention will be apparent to one of routine skill in this field. Such variations and other implementations are considered part of the present invention and within the scope of the appended claims. Accordingly, reference should be made to the appended claims, rather than to the forgoing specification and drawings, as indicating the scope of the present invention.

I claim:

1. A computer implemented process including software logic for connecting and centrally managing a plurality of multi-tier server computer systems for activities or chance or gaming as a single virtual structured network of unlimited size having a network ring structure, a tree structure, or a combination of a network ring and network tree structure, and managing the virtual structured network of tiered server systems, individual end users or groups of end users from a central location that has access to a repository of information with details regarding each server system, individual end users or groups of end users included within the network, wherein said process comprises the steps of:
(a) creating one to many and many to many connections between a central server or central server network and two or more second tier server systems that may serve as a node whereby they are in turn optionally connected in a similar manner to form a tree structure, a ring network or a combination thereof, wherein nodes on the ring or tree structure can be connected to one or more sub-tier server systems,
(b) loading from or persisting to at least one storage facility system the information and connection parameters with respect to the server systems managed in the virtual structured network that are necessary to manage the virtual structure network with respect to activities of chance, gaming or investing,
(c) loading into the memory of at least one computer system in a network one or more software modules capable of:
(i) monitoring any additions, deletions or changes to server computer systems within the virtual structured network,
(ii) monitoring any additions, deletions, or changes to one or more clients connected to a server within the virtual structured network, and
(iii) persisting such information to at least one repository of information utilized to manage the virtual structured network,
(d) connecting to one or more a client systems directly to a central server system portal through an intranet or internet network connection, accessing information in a repository regarding said one or more client systems, individual end users, or groups of end users, and delegating the connection to one or more tiered servers within the virtual single network system based upon accessed information regarding said one or more client systems, individual end users or groups of end users, including the steps of:
(i) accessing information in a repository regarding said one or more client systems, individual end users or groups of individual end users that have connected to a central server system portal through an intranet or internet connection;
(ii) transmitting a request to transfer a connection with a client system to one or more tiered servers within said plurality of tiered server systems;
(iii) transmitting one or more addresses, of said available server systems connected within said virtual structured network to said client system attached to the portal, or transmitting the address of the client system to one or more server systems; and
(iv) establishing connections between said one or more tiered server systems and the client system within said virtual structured network,
(v) monitoring or delegating the monitoring of maintenance of connections between the client system and said one or more tiered server systems within said structured network.

2. The process of claim 1, additionally comprising a step (e) of maintaining a pre-determined number of connections between each client system that is connected to one or more servers in the plurality of tiered server systems and monitoring the connections with the software of (c) to receive information from said tiered server systems and the connected client system adequate to maintain the status of connections, to establish new connections, or to both maintain the status of connections and establish new of the client system with the tiered server system when a disconnection from at least one server occurs.

3. The process of claim 1, wherein each node on the virtual network that is available for connections with client systems has a pre-determined number of possible connections to existing or new clients systems as a capacity that is stored as information maintained and updated in an information repository that can be accessed by software, which is used to monitor or delegate the monitoring of maintenance of connections between the virtual network and client systems.

4. The process of claim 2, wherein said step (c) includes the steps of:
(f) transmitting a disconnection notification from a server system to said monitoring software of (c) that a server system has partly or fully disconnected from a client system within said plurality thereof, wherein said partly disconnected client system has been connected for receiving information from said server system;
(g) said software of (f) responding to said notification of partial disconnection by at least one of the following actions
(i) transmitting instructions to other servers on the network to creating additional connections of the client system to the virtual network,
(ii) transmitting addresses and connection information to the partially disconnected client system to permit it to connect with other servers within the virtual network, and
(iii) transmitting instructions to the servers having current connections with said client system to disconnect said client system from the virtual network

5. A process executing within the virtual network of claim 1 for establishing a parent-child relationship between the virtual network and sub-branches of the of virtual network server tree system, between the virtual network and a subordinate circular network, or a combination thereof, and providing a virtual private network for a pre-determined plurality of server systems, client systems or a combination thereof within the virtual network.

6. The process of claim 5, executing within said server system further providing logic and means for establishing a private network of client systems within a plurality thereof such that server systems and client systems may transmit information, receive information, or a combination thereof, said process comprising the steps of:
(a) receiving a request for connection to a virtual private network from a client system issuing said request;
(b) determining if said client system has permission to connect to said virtual private network and executing one or more of the following actions
(i) refusing connection to the virtual private network,
(ii) requiring actions from said requesting client system in order to receive permission to connect to said virtual private network, and
(iii) verifying that said client system has permission for connecting to said virtual private network;
(c) after verifying that client system has permission for connecting, determining if a port of said server system within said virtual private network is available for connection with said requesting client system;
(d) if a port of said server system within said virtual private network is available for connection, as determined in step (c), executing actions for connecting said client system issuing said request to said virtual private network;
(e) if a port of said server system is not available for connection within said private network, as determined in step (b), sending to said client system issuing said request a first predetermined number of addresses of available client systems within said plurality thereof connected within said private network, or suggesting postponing connection to the virtual private network; and
(f) adding information to one or more repositories within the virtual network regarding the said client system issuing said request and their level of permission to join or participate in the virtual private network.
